(19) United States
(12) Patent Application Publication
(10) Pub. No.: US 2003/0215553 A1
(43) Pub. Date: Nov. 20, 2003

(54) Method for preparing non wrapped hard candies based on maltitol syrup

(76) Inventors: Guillaume Ribadeau-Dumas, Verlinghem (FR); Bruno Dauchy, Lestrem (FR)

Correspondence Address: Michael O. Sturm, STURM & FIX LLP, Suite 1213, 206 Sixth Avenue, Des Moines, IA, 50309-4076, US

(21) Appl. No.: 10/348,120

(22) Filed: Jan. 21, 2003

(30) Foreign Application Priority Data
May 16, 2002 (WO) PCT/FR02/01650

(51) Int. Cl. A23L 1/236

(52) U.S. Cl. 426/548

(57) ABSTRACT

The invention concerns a method for preparing sugar-free non-packaged hard-boiled candies, which consists in cooking a maltitol syrup, characterised in that said syrup comprises relative to dry matter 67 to 77%, preferably 70 to 75 wt. % of maltitol and 9 to 20% , preferably 10 to 18% of polysaccharides non-hydrolysable by amyloglucosidase. The invention also concerns a sugar-free non-packaged hard-boiled candy characterised in that it comprises relative to its dry matter 65 to 77%, preferably 70 to 75% of maltitol and 9 to 20%, preferably 10 to 18% of polysaccharides non hydrolysable by amyloglucosidase.

The present invention relates to a method of preparing non wrapped hard candies containing maltitol syrup. For the purposes of the present invention, non wrapped hard candies are hard candies intended for sale without individual packaging.

The invention likewise relates to novel non wrapped hard candies containing maltitol syrup.

Hard candies, commonly also referred to as boiled sweets, are solid and essentially amorphous confectionery products.

In France and elsewhere, a great many confectioners nowadays sell sugarless confectionery. Their objective is to meet the expectations of a growing number of consumers who are more concerned than in the past about their diet and a healthy lifestyle. The beginnings of sugarless confectionery go back to the 1950s, when the first industrial hard candies appeared on the German market. These were products based on sorbitol which were obtained by casting. Said polyol replaced both the sugar and the glucose syrups traditionally employed in this application. Sorbitol hard candies are atypical products in that they are essentially crystalline.

Subsequently, the development of the maltitol syrup LYCASIN® 80/55, a noncariogenic and noncrystallizable product developed by the Applicant, made it possible to manufacture completely amorphous boiled sweets which were comparable in terms of vitreous state with traditional hard candies. Today, other polyols have appeared on the market, with their advantages and their drawbacks for the manufacture of sugarless hard candies.

Hard candies are hygroscopic products, which, when stored under normal temperature and moisture conditions, have a tendency to absorb moisture from the atmosphere and, consequently, have a tendency to become sticky. To prevent hard candies sticking to one another, which would make them difficult to consume, they are generally packaged individually, by means for example of paper wrappers which are more or less impervious to water vapor. Paperwrapped hard candies are generally packed in bags which likewise contribute to forming a more or less impervious barrier between the hard candy and the atmospheric moisture, so further enhancing the preservation of the hard candies.

The conventional hard candies most commonly encountered on the market, which contain approximately 2 to 5% of residual water and whose solids content is generally composed of from 10 to 60% of sucrose and from 40 to 90% of glucose syrup dry matter, and the sugarless hard candies based essentially on maltitol syrups are generally packaged individually and packed in bags.

In order to reduce the cost of their packaging materials and to meet the expectations of consumers who are looking for practical products without individual packaging, the manufacturers of hard candies have always sought to reduce their hygroscopicity in order to allow them to be sold, without individual packaging, in less expensive packaging, such as cardboard boxes, for example.

A number of solutions have been developed. Isomalt has made it possible to respond to this concern for stability, and no longer makes it necessary to have impervious packaging, which is complex and expensive.

Isomalt, however, is an expensive product and consequently is poorly suited to use as a bulking agent for mass-manufactured products.

Other solutions exist at the present time for allowing the preparation of hard candies which are sufficiently stable on storage.

The first such solution consists in producing hard candies based on sorbitol. Said polyol allows the preparation of hard candies which remain stable toward moisture by virtue of a microcrystallization of the polyol in the mass and at the surface. This microcrystallization is not visible to the naked eye, and the hard candy is translucent immediately after its manufacture. Over time, however, it has a tendency to whiten at the surface, so reducing its esthetic appeal. Moreover, hard candies containing sorbitol cannot be formed but can only be cast, and their hardening is very slow (generally more than one hour) since it involves a crystallization process. The hardening of other vitreous hard candies depends only on the rate of cooling of the hard candies, and takes no more than a few minutes.

The second solution consists in frosting the hard candy, as described for example in patent EP 0 630 575, of which the Applicant is proprietor. Frosting consists in applying to the surface of the hard candy a crystallizable syrup, most frequently of sucrose. Crystallization of the sucrose at the surface of the hard candy thereby creates a barrier to aqueous exchange. However, frosting removes the criterion of translucency from the frosted hard candy, which has a whitish appearance. Another solution consists in a technique referred to as oiling, which is a coating by means of fatty substances of the mono- and diglyceride type, this technique being intended essentially for jellified confectionery, generally of pharmaceutical type. The drawback of this method is that it does not create an effective barrier to the ambient air moisture, on the one hand, and, on the other hand, that it gives the confectionery a fatty texture which is unsuited in particular to cardboard packaging, and which is disagreeable for the consumer.

The third solution consists in providing a specific carbohydrate composition which makes it possible to obtain a sugarless hard candy which is stable to moisture and to heat and which does not have a tendency, over time, to become opaque and white at the surface or at the core.

A number of compositions have thus been proposed. For example, the patent EP 0 561 089, of which the Applicant is proprietor, proposes a hydrogenated saccharide composition which has a specific profile, said composition being selected so as to impart enhanced stability to the hard candies. Said saccharides, however, are not intended for the manufacture of non wrapped hard candies, since the hard candies prepared with this type of composition must necessarily be paperwrapped. Other solutions based on isomalt exist in order to produce sugarless hard candies which are sufficiently stable to allow them to be sold without individual packaging.

Specifically, it is possible to use mixtures comprising 60 to 80% of isomalt and 20 to 40% of maltitol syrup, or 20 to 40% of polydextrose. These mixtures, however, are expensive.

It is also possible to employ the method described in the patent EP 518 770, of which the Applicant is proprietor. This method, however, proves relatively complex.

Another solution has also been proposed in the patent application FR 01 02677, of which the Applicant is proprietor, and consists in coating the sugarless hard candies in such a way as to create a hard and translucent coating, using a syrup comprising at least one polyol, at least one high molecular weight polysaccharide and at least one fatty substance. Said coating, however, constitutes an additional step relative to the traditional methods of manufacturing hard candies.

In the document U.S. Pat. No. 5,236,719, a dextrin from which the low molecular weight compounds have been removed by chromatography, which is sold under the name FIBERSOL G, is used in combination with xylitol, sorbitol or maltitol in the manufacture of hard candies. The maltitol hard candies described contain approximately 10% of a 75% maltitol syrup, and 80% of dextrin. As soon as the hard candies prepared from such compositions are in contact with the atmosphere, they have a tendency to absorb water and to become sticky. As a consequence, they absolutely must be packaged individually.

Finally, the document EP-A1-0 954 982, of which the Applicant is proprietor, describes hard candies containing 50% of maltitol and 50% of a crystallization inhibitor which may be, for example, a hydrogenated dextrin, these hard candies likewise having to be packaged individually owing to their excessively sticky nature.

The aim of the invention is therefore to overcome the drawbacks of the prior art and to provide a novel method of preparing sugarless non wrapped hard candies which are translucent and represent a significantly improved response to the expectations of confectioners and to the various demands of the art, namely products in accordance with traditional methods of manufacturing conventional and sugarless hard candies, and which possess a markedly enhanced stability on storage which thus allows them to be packed without individual packaging.

Following in-depth research, the Applicant has had the merit to find that this aim can be achieved and that, contrary to all expectation, it is possible to prepare a stable hard candy containing maltitol syrup which is non wrapped, and in particular is not paperwrapped, when it is prepared by a specific, appropriate method employing a specific maltitol syrup.

The hard candy according to the invention may be qualified as stable in so far as, over time and without individual packaging, it has no tendency:

either to become sticky

or to undergo deformation at the summer temperatures common in temperate climates.

The Applicant has discovered that, surprisingly and unexpectedly, using a specific method, employing advantageously a specific maltitol syrup, it is possible to prepare non wrapped hard candies of very high quality which are only very slightly sticky if at all.

Pursuing its research work, the Applicant found that the use of a specific maltitol syrup containing 67 to 77% by weight solids of maltitol and 9 to 20% of polysaccharides which are not hydrolyzable by amyloglucosidase was an essential factor allowing the set aim to be attained.

This is particularly surprising in the light of the numerous technical prejudices which had hitherto arisen.

Specifically, the maltitol hard candies of the prior art, which have maltitol contents of between 50 and 86%, as described in the documents EP-B1-0 561 088 or EP-B1-0 533 334, are all insufficiently stable to be sold without individual packaging. It is in effect established, in particular in the document EP-B1-0533334, that the use of syrups containing less than 77% solids maltitol leads to hard candies which are highly hygroscopic and very sticky and have a tendency to become runny, while retaining essentially a vitreous appearance, whereas the use of syrups containing more than 86% solids maltitol results in hard candies which become matt and opaque, owing to the crystallization of the maltitol from their surface to the core. The preferred range is therefore situated between 77 and 86% of maltitol, but results in hard candies which are stable only in the presence of an individual paper wrapper. This teaching is confirmed in the document “Developments in Sweeteners—3” edited by T. H. Grenby and published by Elsevier Applied Science, in the chapter by I. Fabry “MALBIT and its applications in the Food Industry”, pages 83 to 108, in which it is indicated on page 97 that all the hard candies prepared starting from MALBIT® maltitol syrups are necessarily packaged with a material which is highly impermeable to water vapor.

Also described, in the document EP-B1-0611527, of which the Applicant is proprietor, are hard candies prepared starting from syrups which are very rich in maltitol (more than 78% solids), which again are stable only when paperwrapped.

The present invention accordingly provides a method of preparing non wrapped hard candies containing maltitol syrup, comprising the cooking of a maltitol syrup, characterized in that said syrup contains 67 to 77% by dry weight of maltitol and 9 to 20% by dry weight of polysaccharides which are not hydrolyzable by amyloglucosidase. Preferably, said maltitol syrup contains 70 to 75% by weight solids of maltitol and 10 to 18% of polysaccharides which are not hydrolyzable by amyloglucosidase.

The Applicant has in effect found, after lengthy research work, that the hard candies which are not packaged individually, prepared using a specific maltitol syrup of this kind, undergo, surprisingly and unexpectedly, a transitory phase of slight stickiness, after which said hard candies no longer stick to one another and remain effectively separated over time. This transitory phase of stickiness is substantially reduced if the hard candies are subjected, following manufacture and prior to boxing, to a maturation phase at ambient temperature and moisture, at the end of which the hard candies are completely stable without individual packaging. However, very good results are obtained without employing said maturation phase.

According to one general embodiment of the invention, the method consists in using the conventional techniques known to the skilled worker to cook a syrup containing 67 to 77%, preferably 70 to 75%, of maltitol by weight solids and 9 to 20%, preferably 10 to 18%, of polysaccharides which are not hydrolyzable by amyloglucosidase so as to give a final water content in the non wrapped hard candy of less than 5% and preferably between 1 and 3.5%. By way of indication, a temperature of 180° C. at atmospheric pressure is suitable, or else temperatures of less than 180° C. under vacuum. After said maltitol syrup has been cooked, it is possible to add to the cooked mass one or more ingredients selected from the group consisting of flavorings, intensive sweeteners, acids, pharmaceutical active principles, minerals such as calcium or magnesium, and colorings. The hard candy is finally shaped by casting or forming in accordance with the conventional art and is packed, for example, in cardboard boxes, without individual packaging.

As far as the maltitol syrup employed in accordance with the invention is concerned, such a syrup may be prepared by any means, advantageously in accordance with the method described by the Applicant in the document EP-B1-561089, such that said maltitol syrup contains from 67 to 77% of maltitol by weight solids and 9 to 20% of polysaccharides which are not hydrolyzable by amyloglucosidase.

By polysaccharides which are not hydrolyzable by amyloglucosidase are meant the polysaccharides as described in the document EP-B1-0561089, corresponding to the definition of total dietary fiber, whose amount is determined by a test F corresponding to the assay developed by the SIGMA Chemical Company and defined in detail in said document, to which it will be possible to refer.

Said maltitol syrup preferably further comprises less than 5% by weight solids of hydrogenated monosaccharides. Said maltitol syrup in particular comprises less than 5% by weight solids of sorbitol.

The remainder to 100% of said maltitol syrup according to the invention may be composed of any compound suitable for the preparation of sugarless hard candies, such as, for example, hydrogenated isomaltulose (known under the name ISOMALT), indigestible dextrins such as in particular those known under the name FIBERSOL which are sold by the MATSUTANI Company, hydrogenated oligo- and polysaccharides, such as in particular maltotriitol, maltotetraitol, and other hydrogenated oligo- and polysaccharides obtained by hydrolysis of starch followed by hydrogenation.

As far as the concentration of water in the syrup employed according to the invention is concerned, it is preferred to select a solids content such that the syrup at 20° C. is supersaturated with maltitol and that the latter is present in the amorphous state at the customary storage temperatures. In general, it is greater than 60%, preferably greater than 65%, and more preferably close to 70%.

The invention likewise provides a non wrapped, sugarless hard candy characterized in that it comprises in relation to its solids content 65 to 77%, preferably 70 to 75%, by weight of maltitol and 9 to 20%, preferably 10 to 18%, of polysaccharides which are not hydrolyzable by amyloglucosidase.

As far as the Applicant is aware, non wrapped, sugarless hard candies of this kind, which are stable on storage and are therefore suitable for packing without individual packaging, are novel industrial products. Specifically, no prior art hard candy prepared from maltitol syrups is sufficiently stable to be packed non wrapped.

As far as the water content of the non wrapped hard candies of the invention is concerned, it is advantageously less than 5% and preferably between 1 and 3.5%.

At least one intensive sweetener may form part of the composition of the non wrapped hard candies in accordance with the invention, such as aspartame, acesulfame K, sucralose, and steviosides, without this list being limitative. The purpose of these sweeteners is to adjust the organoleptic properties of the hard candies of the invention.

Likewise, and depending on the intended applications, the non wrapped hard candies of the invention may further comprise a compound selected from the group consisting of flavorings, colorings, acids, plant extracts, vitamins, pharmaceutical active principles, and minerals such as calcium or magnesium, alone or as a mixture with one another.

The invention further provides a specific maltitol syrup characterized in that it comprises in relation to its solids content 67 to 77% and preferably 70 to 75% by weight of maltitol and 9 to 20%, preferably 10 to 18%, of polysaccharides which are not hydrolyzable by amyloglucosidase, less than 5% of hydrogenated monosaccharides, the remainder to 100% being composed of a compound selected from the group consisting of hydrogenated isomaltulose, indigestible dextrins, and hydrogenated oligo- and polysaccharides. In one advantageous variant the remainder to 100% of said maltitol syrup is composed of hydrogenated oligo- and polysaccharides.

This specific, selected maltitol syrup exhibits a surprising and unexpected ability to impart to the sugarless hard candies prepared using it an exceptional stability which allows them to be packed without individual packaging. The invention therefore likewise provides for the use of such a syrup for the manufacture of non wrapped, sugarless hard candies.

The invention will be better understood with the aid of the examples which follow, which are intended to be illustrative and not limitative.

### EXAMPLE 1

Various maltitol syrups are prepared which have maltitol solids contents of 60, 65, 70, 75 and 80% on solids and contain amounts of polysaccharides which are not hydrolyzable by amyloglucosidase in the F test of 10 to 20% solids.

Likewise prepared, for comparison purposes, is a 75% by weight solids maltitol syrup which contains no polysaccharides which are not hydrolyzable by amyloglucosidase (MALTISORB® 75/75 sold by the Applicant) . The compositions of these syrups are given by the following table:

| COMPOSITION OF THE SYRUPS | | | | | | |
|---|---|---|---|---|---|---|
| (% by weight solids) | A | B | C | D | E | F |
| Final maltitol content | 60 | 65 | 70 | 75 | 80 | 75 |
| Polysaccharides not | 20 | 17.5 | 15 | 12.5 | 10 | <5 |
| hydrolyzable by | | | | | | |
| amyloglucosidase according | | | | | | |
| to the F test | | | | | | |

These various syrups are cooked at 180° C. under atmospheric conditions then flavored with mint and colored. Their water content is around 1.5%.

These hard candies are packed in cardboard boxes which are film-wrapped immediately after manufacture, and are placed in a desiccator at 66% relative humidity and 20° C. for 10 days.

The boxes are manipulated during the test so as to evaluate the sticking of the hard candies (candies are mobile or not).

The appearance of the hard candies and the evaluation of the sticking are summarized in the table below. The sticking is rated as follows:

“0” if the candies are mobile in the box

“0+” if the candies are mobile after slight shaking of the box

“+” if the candies remain immobile (stuck to one another) in the box.

| | A | B | C | D | E | F |
|---|---|---|---|---|---|---|
| Sticking after | + | + | 0+ | 0+ | 0 | + |
| 10 days | | | | | | |
| Appearance | Deformed | Stuck to | Micro- | Micro- | Speckled | Deformed |
| of the hard | and stuck | one another | speckled | speckled | (white) | and stuck |
| candies | to one | | | | | to one |
| | another | | | | another | |

The hard candies obtained with syrups A and B are unsatisfactory from the standpoint of sticking; their maltitol content is insufficient to retard water absorption.

The hard candies obtained with syrup E do not stick but whiten very quickly, which is detrimental to their appearance and makes them unsuitable for sale.

The hard candies obtained with syrup F, although having the same maltitol content as the hard candies D, cannot be sold without individual packaging.

In contrast, the hard candies obtained with syrups C and D (according to the invention) are entirely satisfactory. They exhibit a microscopic speckling without detrimental effect to their appearance. These hard candies are therefore entirely capable of being packed non wrapped.

### EXAMPLE 2

The kinetics of sticking at 66% relative humidity and 20° C. of the hard candies prepared above with syrup D, divided into two batches, are studied. The first batch is packed immediately after manufacture in cardboard boxes; the second batch undergoes a four-day maturation phase beforehand under the conditions of the sticking test. These two batches are subsequently subjected to the sticking test at 66% relative humidity and 20° C. for 10 days. The sticking is rated in the same way as before.

The results are given in the following table:

| | Matured hard | Nonmatured hard |
|---|---|---|
| | candies | candies |
| 1 day | -- (maturation) | 0 |
| 2 days | -- (maturation) | 0 |
| 3 days | -- (maturation) | 0 |
| 4 days | -- (maturation) | 0+ |
| 7 days | 0 | 0+ |
| 9 days | 0 | 0 |
| 10 days | 0 | 0 |

The hard candies, matured or not, are entirely satisfactory in terms of sticking. The results demonstrate, for the nonmatured hard candies, the transitory sticking phase of several days, which has no detrimental consequence for the final stability of the hard candies in accordance with the invention.

1. A method of preparing non wrapped, sugarless hard candies, comprising a step of cooking a maltitol syrup, characterized in that said syrup contains 67 to 77%, preferably 70 to 75%, by weight solids of maltitol and 9 to 20%, preferably 10 to 18%, of polysaccharides which are not hydrolyzable by amyloglucosidase.

2. The method of claim 1, characterized in that said maltitol syrup further comprises less than 5% by weight of hydrogenated monosaccharides, and in particular less than 5% of sorbitol.

3. The method of one or the other of claims 1 and 2, characterized in that said maltitol syrup further comprises at least one compound selected from the group consisting of hydrogenated isomaltulose, indigestible dextrins, and hydrogenated oligo- and polysaccharides.

4. The method of any one of claims 1 to 3, characterized in that it further comprises a step of maturation at ambient temperature before packing.

5. A non wrapped, sugarless hard candy characterized in that it contains in relation to its solids content 65 to 77%, preferably 70 to 75%, of maltitol and 9 to 20%, preferably 10 to 18%, of polysaccharides which are not hydrolyzable by amyloglucosidase.

6. The non wrapped, sugarless hard candy of claim 5, characterized in that it further comprises a compound selected from the group consisting of intensive sweeteners, flavorings, colorings, plant extracts, vitamins, pharmaceutical active principles, organic acids and minerals, alone or as a mixture with one another.

7. The non wrapped, sugarless hard candy of one or the other of claims 5 and 6, characterized in that it exhibits a water content of less than 5% and preferably of between 1 and 3.5%.

8. A maltitol syrup characterized in that it comprises in relation to its solids content 67 to 77%, preferably 70 to 75%, by weight of maltitol and 9 to 20%, preferably 10 to 18%, of polysaccharides which are not hydrolyzable by amyloglucosidase, less than 5% of hydrogenated monosaccharides, the remainder to 100% being composed of hydrogenated oligo- and polysaccharides.
